(19) United States
(12) Patent Application Publication
(10) Pub. No.: US 2007/0295684 A1
(43) Pub. Date: Dec. 27, 2007

(54) Heat Insulated Container

(76) Inventors: Takafumi Fujii, Tsubame-shi (JP); Yu Kobayashi, Tsubame-shi (JP)

Correspondence Address: QUARLES & BRADY LLP, 411 E. WISCONSIN AVENUE, SUITE 2040, MILWAUKEE, WI, 53202-4497, US

(21) Appl. No.: 11/667,536

(22) PCT Filed: Mar. 23, 2005
(86) PCT No.: PCT/JP05/05280

§ 371 Date: May 10, 2007

(51) Int. Cl. A47J 41/02; B65D 81/38

(52) U.S. Cl. 215/12.1; 220/592.27

(57) ABSTRACT

An object is to prevent cracking of a radiant heat preventing film which occurs near an opening area. A heat insulated container 10 produced by coating an external surface of a glass internal container 12 with a radiant heat preventing film 24, disposing the internal container 12 inside an external container 16 with a gap 14 interposed therebetween, heating an opening area so as to melt the same to thereby unite the internal container 12 with the external container 16, and evacuating the gap 14 to a vacuum, is characterized in that a region 26 not coated with the radiant heat preventing film 24 is provided in the vicinity of the opening area of the external surface. As a result, cracking does not occur in the radiant heat preventing film 24 at the time of heating and melting the opening area 18. Accordingly, even if the vicinity of the opening area 18 is deformed at the time of uniting, there is no intrusion of the radiant heat preventing film 24 into the glass interior, no occurrence of cracking, and no occurrence of oozing of glass from the cracked portion leading to formation of protrusions. Therefore, breakage of the heat insulated container attributed to stress concentration in the vicinity of the opening area is radically reduced, and the fraction defective is lowered, thereby enabling a reduction in production cost. Furthermore, any whitening phenomenon is also prevented, thereby avoiding any deterioration of appearance.

### TECHNICAL FIELD

The present invention relates to a heat insulated container, and more specifically, relates to a glass heat insulated container formed by uniting an internal container with an external container and evacuating a gap therebetween to a vacuum.

### BACKGROUND ART

Conventionally, a glass heat insulated container is produced by disposing a glass internal container inside a glass external container with a constant gap provided therebetween, heating a vicinity of an opening area by a gas burner or the like so as to melt the vicinity of the opening area to thereby integrally unite the internal container with the external container, and evacuating the gap to a vacuum to thereby provide a vacuum insulating layer. Moreover an external surface of the internal container is coated with a radiant heat preventing film such as an ITO film (a substance produced by doping indium (In) oxide with tin (Sn)) so as to decrease movement of heat between the inside and outside of the heat insulated container (for example, refer to Patent Document 1).

Patent Document 1: Japanese Unexamined Patent Publication No. 2003-299582

### DISCLOSURE OF THE INVENTION

### Problems to be Solved by the Invention

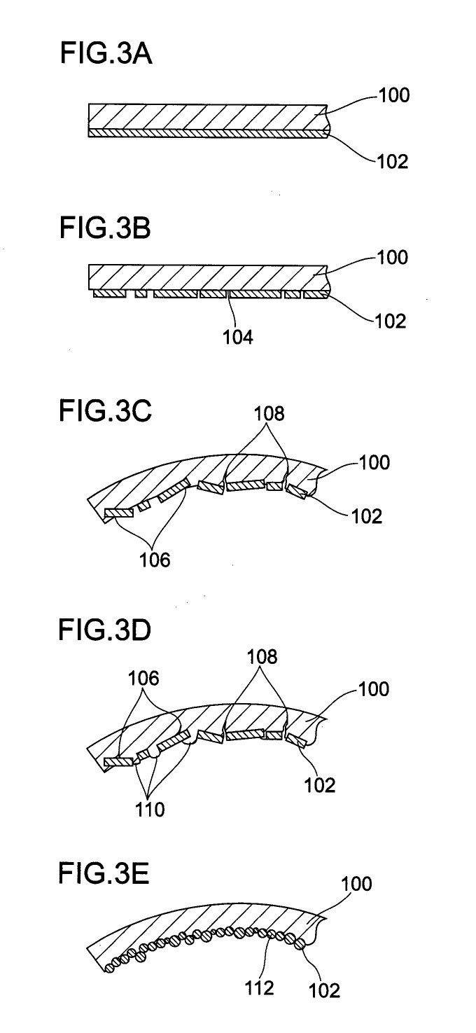

However, when the radiant heat preventing film is coated up to the vicinity of the opening area of the internal container, there is a problem in that the radiant heat preventing film is also heated at the time of heating the vicinity of the opening area by the gas burner, thereby promoting rapid oxidation so that the radiant heat preventing function is damaged. Moreover even when as shown in FIG. 3(A), a radiant heat preventing film 102 is uniformly coated on a glass 100 before heating, cracking 104 may occur, since the coefficient of thermal expansion of the glass 100 is larger than that of the radiant heat preventing film 102 when heated. If a portion where the cracking 104 has occurred is deformed, a fragment of the radiant heat preventing film 102 may intrude into the glass as shown by 106 in FIG. 3(C), and a crevice 108 may occur at the cracked position, since the radiant heat preventing film 102 is harder than the glass 100. Moreover, it is found that as shown in FIG. 3(D), oozing of the softened glass may occur from the cracked portion leading to formation of protrusions 110. When the glass 100 is continuously heated, as shown in FIG. 3(E), there is a problem in that the radiant heat preventing film 102 microscopically forms spheres 112, and macroscopically causes a whitening phenomenon such that the radiant heat preventing film 102 becomes white. It is considered that such a whitening phenomenon occurs because flames at the time of welding blow off a part of the radiant heat preventing film 102, and hence the radiant heat preventing film 102 becomes porous, and granular ITO is left, or because crystallization of an amorphous portion is promoted due to heating so that the radiant heat preventing film 102 becomes porous.

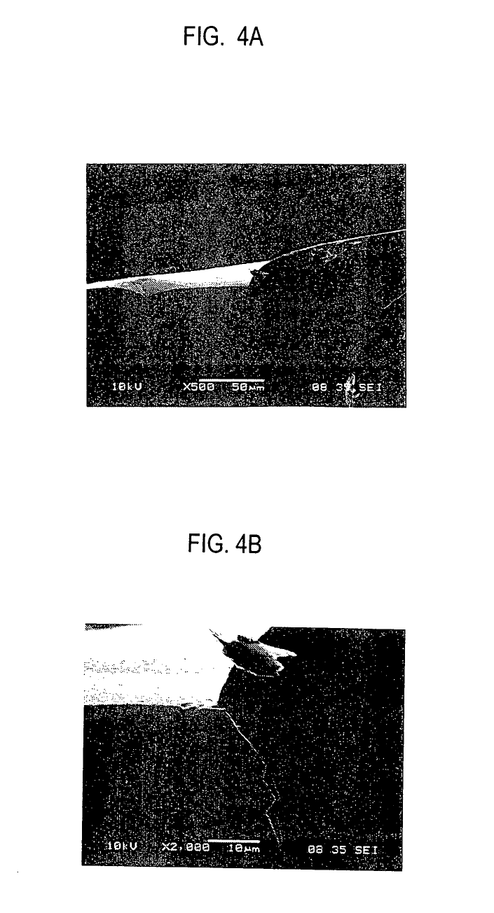

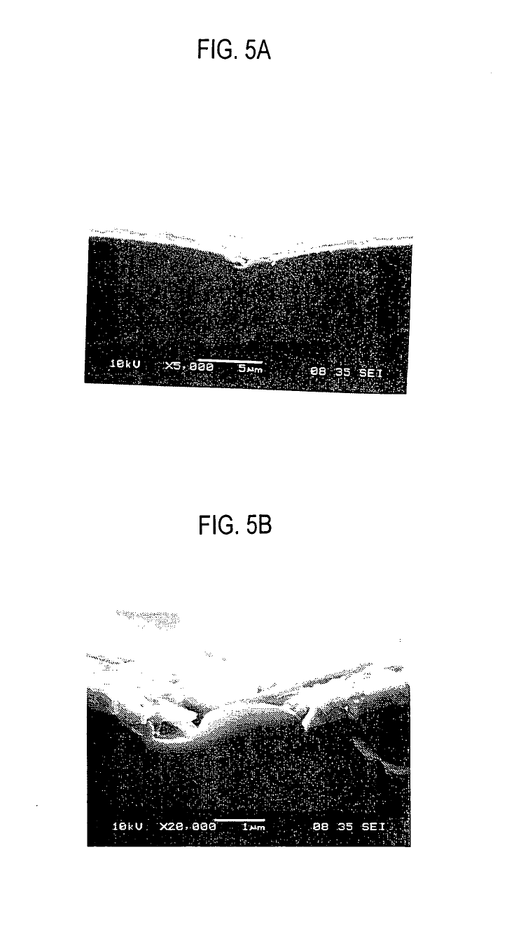

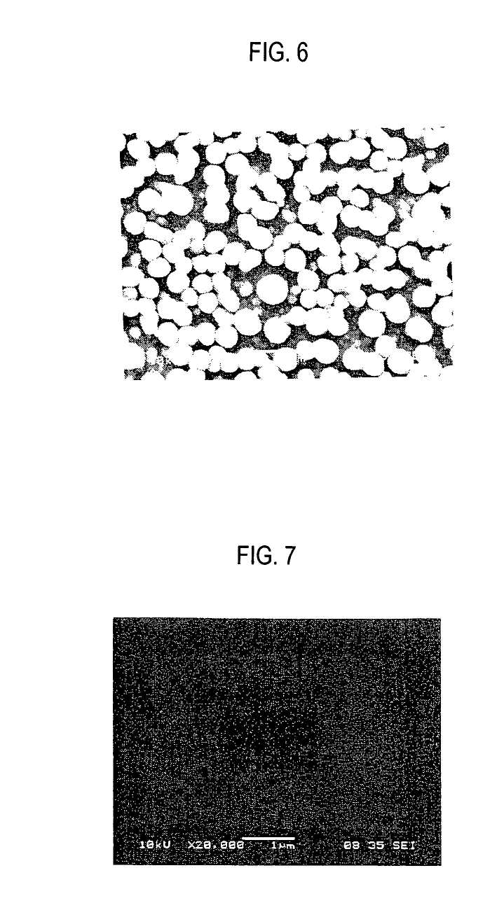

FIG. 4 shows electron microscope (hereinafter, referred to as “SEM”) photographs of the glass where cracking has occurred, due to heating of the glass coated with the ITO film as the radiant heat preventing film. FIG. 4(A) is an enlarged SEM photograph of a cross-section of the cracked portion at a magnification of 500 times, and FIG. 4(B) is an enlarged photograph of the same portion as in FIG. 4(A) at a magnification of 2,000 times. From these a state where the cracked ITO film has intruded into the glass is observed. FIG. 5(A) is an enlarged SEM photograph of a portion different from FIG. 4 in which cracking has occurred in the ITO film at a magnification of 5,000 times, and FIG. 5(B) is an enlarged SEM photograph of the same portion as in FIG. 5(A) at a magnification of 20,000 times. From these it is seen that the glass melts from the cracked portion of the ITO film to form a protrusion. FIG. 6 is an enlarged SEM photograph of a portion where the whitening phenomenon has occurred at a magnification of 20,000 times. From these it is seen that the ITO forms spheres. FIG. 7 is an enlarged SEM photograph of a part of an unheated glass surface where the ITO film is coated at a magnification of 20,000 times for comparison with FIGS. 4 to 6.

When hot water or very low temperature liquid is put in such a heat insulated container having cracks in the vicinity of the opening area, or vibration is applied at the time of carrying the heat insulated container, a force is applied to these cracked portions to cause stress concentration on these cracked portions, thereby increasing a probability for the heat insulated container to crack. Moreover, there is also a problem in that the appearance of the heat insulated container having a whitened portion near the opening area is deteriorated.

The present invention has been achieved to solve these problems, and it is an object of the present invention to prevent cracking of the radiant heat preventing film which occurs near the opening area.

### Means of Solving the Problems

The present invention provides a heat insulated container produced by coating at least one of a glass internal container and a glass external container with a radiant heat preventing film, disposing the internal container inside the external container with a gap interposed therebetween, heating the vicinity of an opening area of the internal container and/or the external container so as to melt the vicinity of the opening area, to thereby unite the internal container with the external container, and evacuating the gap to a vacuum and sealing the gap, wherein a region not coated with the radiant heat preventing film is provided in the vicinity of an opening area on a face coated with the radiant heat preventing film.

In the heat insulated container of the present invention, the non-coated region is a region to be heated at the time of uniting the internal container with the external container.

Moreover, the present invention provides a heat insulated container produced by coating at least one of a glass internal container and a glass external container with a radiant heat preventing film, disposing the internal container inside the external container with a gap interposed therebetween, heating the vicinity of an opening area of the internal container and/or the external container so as to melt the vicinity of the opening area, to thereby unite the internal container with the external container, and evacuating the gap to a vacuum and sealing the gap, wherein the vicinity of an opening area of the heat insulated container does not exhibit a whitened state and is transparent.

### EFFECTS OF THE INVENTION

According to the heat insulated container of the present invention, since a region not coated with the radiant heat preventing film, that is, a region on which the radiant heat preventing film is not coated is provided near the opening area, any cracking does not occur in the radiant heat preventing film at the time of heating and melting the vicinity of the opening area. Accordingly, even if the vicinity of the opening area is deformed at the time of uniting, there is no intrusion of the radiant heat preventing film into the glass interior, no occurrence of cracking, and no occurrence of oozing of glass from the cracked portion leading to formation of protrusions. Therefore, breakage of the heat insulated container attributed to stress concentration on the vicinity of the opening area is radically reduced, and the fraction defective is lowered, thereby enabling a reduction in production cost. Furthermore, any whitening phenomenon is also prevented, thereby avoiding any deterioration of appearance.

Moreover, since the non-coated region is a region to be heated at the time of uniting the internal container with the external container, the non-coated region is a necessity minimum area, and hence, a decrease in the radiant heat preventing effect can be suppressed to minimum.

Furthermore, the vicinity of the opening area of the heat insulated container does not exhibit the whitening phenomenon and is transparent. Therefore, the appearance of the heat insulated container is not deteriorated.

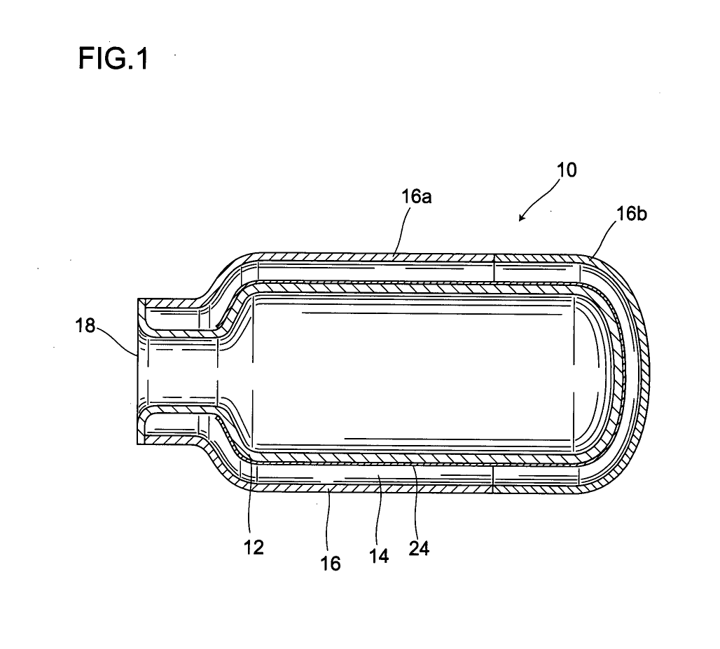

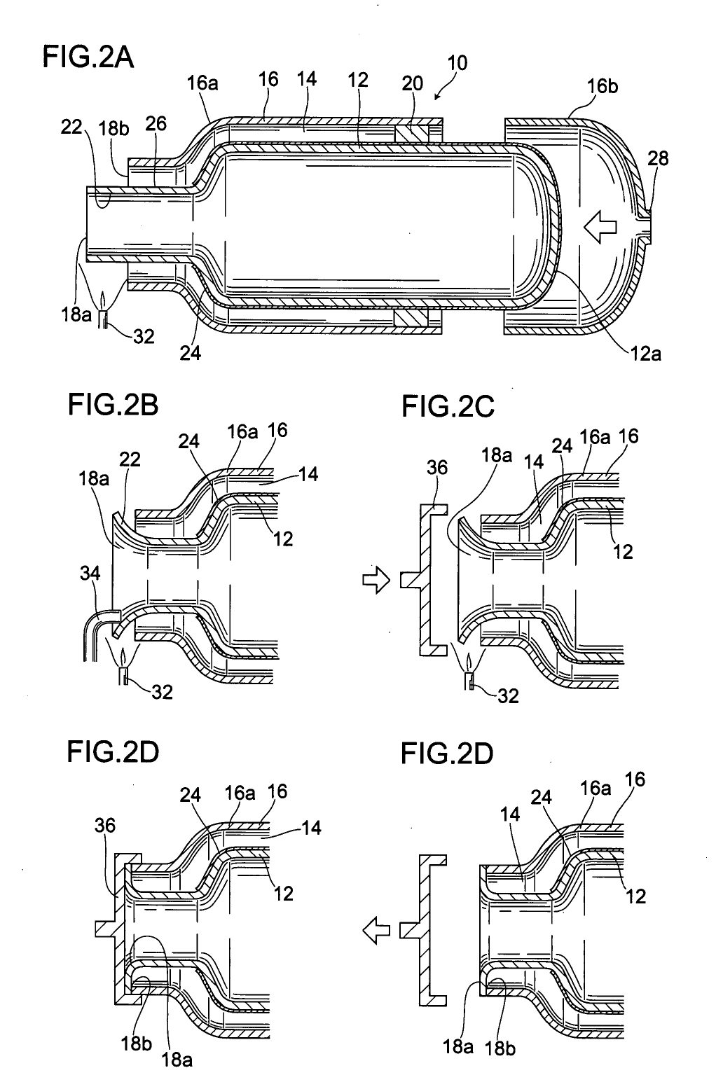

### BRIEF DESCRIPTION OF THE DRAWING

[FIG 1 ] is a schematic block diagram of a heat insulated container of a preferred embodiment of the present invention.

[FIG. 2] is a diagram showing an aspect where an internal container and an external container of the heat insulated container in the preferred embodiment of the present invention are connected with each other, wherein FIG. 2(A) is a diagram in which the internal container is arranged in an upper external container, and FIGS. 2(B) to 2(E) are diagrams showing the steps for joining opening areas thereof.

[FIG. 3] is a diagram for explaining a conventional technology, which shows a state in which a glass coated with a radiant heat preventing film is heated, wherein FIG. 3(A) shows a state before heating, FIG. 3(B) shows a state in which the glass expands due to heating to cause cracking in the radiant heat preventing film, FIG. 3(C) shows a state in which the glass is deformed while in the cracked state of FIG. 3(B), FIG. 3(D) shows a state in which protrusions are formed, and FIG. 3(E) shows a state in which ITO forms spheres due to heating of the glass.

[FIG. 4] is an SEM photograph of a cross-section of an ITO film where cracking has occurred, wherein FIG. 4(A) is an enlarged photograph at a magnification of 500 times, and FIG. 4(B) is an enlarged photograph at a magnification of 2,000 times.

[FIG. 5] is an SEM photograph of a different part from that shown in FIG. 4 where cracking has occurred in the ITO film, wherein FIG.5(A) is an enlarged photograph at a magnification of 5,000 times, and FIG. 5(B) is an enlarged photograph at a magnification of 20,000 times.

[FIG. 6] is an enlarged photograph of a whitened part due to generation of spheres, at a magnification of 20,000 times.

[FIG. 7] is an enlarged photograph of the transparent ITO film before heating, at a magnification of 20,000 times.

### DESCRIPTION OF THE REFERENCE SYMBOLS

10 Heat insulated container
12 Internal container
14 Gap
16 External container
18 Opening area
22 Vicinity of opening area
24 Radiant heat preventing film
26 Non-coated region

### BEST MODE FOR CARRYING OUT THE INVENTION

Hereunder is a description of a preferred embodiment of the present invention, with reference to the accompanying drawings.

FIG. 1 is a cross-section of a heat insulated container 10 in the embodiment of the present invention. As shown in the figure, the heat insulated container 10 in the embodiment includes a glass internal container 12, and a glass external container 16 arranged outside of the internal container 12 with a gap 14 having a constant width. The external container 16 is formed by joining an upper external container 16a and a lower external container 16b with each other, and the internal container 12 and the upper external container 16a are joined with each other at an opening area 18. A pad 20 is arranged between a bottom end of the upper external container 16a and an external face of the internal container 12 so that the gap 14 can be provided with a constant width. The gap 14 is maintained in a vacuum state.

The external face of the internal container 12 is coated with a see-through radiant heat preventing film 24, excluding a vicinity 22 of the opening area on the external face. That is, a non-coated region 26 where the radiant heat preventing film 24 is not coated, is formed in the vicinity 22 of the opening area. The non-coated region 26 is a region that is heated and deformed at the time of uniting the internal container 12 with the external container 16. In the present embodiment it is a region within approximately 20 mm or less from the opening area. The area of the non-coated region is not limited thereto, and it can be appropriately changed according to the shape or size of the heat insulated container. Preferably it is 50 mm or less, and more preferably 20 mm or less.

In the embodiment, an aspect where the external face of the internal container 12 is coated with the radiant heat preventing film 24, and the external container 16 is not coated with the radiant heat preventing film 24 is exemplified. However, the radiant heat preventing film 24 can be coated, for example, on the internal face of the external container 16, or can be coated on both the external face of the internal container 12 and the internal face of the external container 16. The radiant heat preventing film 24 may be coated on at least one of the internal container 12 and the external container 16.

Furthermore in the embodiment, the ITO film is used as the radiant heat preventing film 24, but it is not limited thereto and metallic oxide (semiconductor) such as ZnO, SiOₓ, SnO₂, or TiOₓ may be used.

The radiant heat preventing film 24 is coated by a sputtering method in the embodiment, but the film forming method is not limited to sputtering, and may be one involving coating using a CVD, PVD, or a sol-gel method, spraying using a hot spray method or the like, coating using a spin coating method, or coating with a dip coating method.

Next is a description of a manufacturing method of the heat insulated container 10, with reference to FIG. 2. At first, the internal container 12 is molded in a desired shape, and the external container 16 is formed approximately in a similar shape to that of the internal container 12 with a size capable of housing the internal container 12 with the gap 14 therebetween. At this time, the external container 16 is produced by dividing the external container 16 into the upper external container 16a including the opening area 18 and the lower external container 16b including a bottom evacuating tip tube 28.

Then, a region within about 20 mm from the opening area of the internal container 12 is masked by adhering a tape or the like, and the radiant heat preventing film 24 is coated on the external face thereof, using the above described coating method, evaporation method, or sputtering method. Thereafter, the masking is peeled off, to thereby provide the non-coated region 26 of the radiant heat preventing film 24 in the vicinity 22 of the opening area within about 20 mm from the opening area.

Subsequently, as shown in FIG. 2(A), the internal container 12 is disposed in the upper external container 16 so that an opening 18a of the internal container 12 protrudes from an opening 18b of the external container 16. At this time, the pad 20 is placed between the bottom end of the upper external container 16 and the external face of the internal container 12 so that the gap 14 having a constant width can be formed.

Then openings of the internal container 12 and the external container 16 are heated by a burner 32 while the internal container 12 is rotated so as to melt the vicinity 22 of the opening area of the internal container 12 over the whole perimeter. As shown in FIG. 2(B), the melted part is opened outward by an opening jig 34, and a molding jig 36 is pressed against the opening 18a as shown in FIG. 2(C), so that the opening 18a is planarized and matched with the shape of the molding jig 36 as shown in FIG. 2(D), to thereby integrally unite the opening 18a of the internal container 12 with the opening 18b of the external container 16 as shown in FIG. 2(E).

Next, as shown in FIG. 2(A), the lower external container 16b is disposed so as to encapsulate a bottom 12a of the internal container 12 from the bottom 12a as shown by the arrow in the figure, and the upper external container 16a and the lower external container 16b are integrated by welding, to thereby form a double container.

Then the gap 14 is evacuated to a vacuum via the evacuating tip tube 28, and when the gap 14 reaches a predetermined degree of vacuum, for example, equal to or less than 133.3×10⁻³ Pa, the evacuating tip tube 28 is melted and vacuum sealed.

As described above, the heat insulated container 10 in the embodiment is produced by coating at least one of the glass internal container 12 and the glass external container 16 with the radiant heat preventing film 24, disposing the internal container 12 in the external container 16 with the gap 14 interposed therebetween, heating the vicinity of the opening area of the internal container 12 and/or the external container 16 so as to melt the vicinity of the opening area, to thereby unite the internal container 12 with the external container 16, evacuating the gap 14 to a vacuum and sealing the gap 14, wherein the non-coated region 26 of the radiant heat preventing film 24 is provided in the vicinity 22 of the opening area on a face coated with the radiant heat preventing film.

According to the embodiment, since the vicinity 22 of the opening area is not coated with the radiant heat preventing film, any cracking does not occur in the radiant heat preventing film 24 at the time of heating and melting the vicinity 22 of the opening area. Accordingly, even if the vicinity of the opening area 18 is deformed at the time of uniting, there is no intrusion of the radiant heat preventing film 24 into the glass interior, no occurrence of cracking; and no occurrence of oozing of glass from the cracked portion. Therefore, breakage of the heat insulated container attributed to stress concentration on the vicinity 22 of the opening area is radically reduced, and the fraction defective is lowered, thereby enabling a reduction in production cost. Since a phenomenon of abrupt breakage does not occur, safety is also enhanced. Furthermore the whitening phenomenon is prevented, so there is no deterioration in appearance.

Moreover in the heat insulated container 10 in the embodiment, the non-coated region 26 is a region to be heated at the time of uniting the internal container 12 with the external container 16.

Since the non-coated region 26 is a region to be heated at the time of uniting the internal container 12 with the external container 16, the non-coated region 26 is a necessary minimum area, and hence a decrease in the radiant heat preventing effect can be kept to a minimum.

In the heat insulated container 10 in the embodiment, the internal container 12 is coated with the radiant heat preventing film 24, and the vicinity of the opening area of the heat insulated container 10 does not exhibit the whitening phenomenon and is transparent.

Accordingly, since the vicinity of the opening area of the heat insulated container 10 does not exhibit the whitening phenomenon, the appearance of the heat insulated container 10 is not deteriorated.

The preferred embodiment of the present invention has been described above, but the present invention is not limited to the embodiment, and can be modified variously. For example, the shape of the heat insulating container is not limited to the one shown in the drawing, and various shapes can be used. The manufacturing method is not limited to the method for dividing the external container into two. For example, the external container can be integrated with the bottom being opened, and after inserting the internal container from the bottom opening of the external container and disposing the internal container in the external container, the bottom of the external container can be shrunk to form a double heat insulated container. Alternatively, the external container can be integrated with a neck portion being opened, and after inserting the internal container from the neck opening of the external container and disposing the internal container in the external container, the neck of the external container can be shrunk to form a double heat insulated container.

1. A heat insulated container produced by coating at least one of a glass internal container and a glass external container with a radiant heat preventing film, disposing said internal container inside said external container with a gap interposed therebetween, heating the vicinity of an opening area of said internal container and/or said external container so as to melt the vicinity of the opening area, to thereby unite said internal container with said external container, and evacuating said gap to a vacuum and sealing the gap,
wherein a region not coated with said radiant heat preventing film is provided in the vicinity of an opening area on a face coated with said radiant heat preventing film so that cracking of said radiant heat preventing film is prevented.

2. A heat insulated container according to claim 1, wherein said non-coated region is a region to be heated at the time of uniting said internal container with said external container.

3. A heat insulated container produced by coating at least one of a glass internal container and a glass external container with a radiant heat preventing film, disposing said internal container inside said external container with a gap interposed therebetween, heating-the vicinity of an opening area of said internal container and/or said external container so as to melt the vicinity of the opening area, to thereby unite said internal container with said external container, and evacuating said gap to a vacuum and sealing the gap,
wherein the vicinity of an opening area of said heat insulated container does not exhibit a whitened state and is transparent.
